(19) United States
(12) Patent Application Publication
(10) Pub. No.: US 2024/0398176 A1
(43) Pub. Date: Dec. 5, 2024

(54) HANDS-FREE WRIST TOWEL

(71) Applicant: Fatima Harris, Middlesex, NJ (US)

(72) Inventor: Fatima Harris, Middlesex, NJ (US)

(21) Appl. No.: 18/326,445

(22) Filed: May 31, 2023

(51) Int. Cl. A47K 10/02

(52) U.S. Cl. CPC A47K 10/02

(57) ABSTRACT

The present invention relates to a portable, wearable, and accessible hands-free towel comprising a hole to allow the towel to be secured on the arm. This useful for the cleaning and sweeping of messes without having to hold the towel cleaning device in the hand while not in use. A person wearing the towel cleaning device can keep the device accessible while freeing up the hands to manipulate other objects while not cleaning.

### FIELD OF THE INVENTION

The present invention generally relates to a hands-free cleaning device. Specifically, the present invention relates to a portable, wearable, and accessible hands-free towel comprising a hole to allow the towel to be secured on the arm. This can allow for the cleaning and sweeping of messes or sweat without having to hold the cleaning device in a hand while not in use. A person wearing the cleaning device can keep the device accessible while freeing up the hands to manipulate other objects while not cleaning. The hands-free towel is also known as the ‘Z Towel’ or ‘Z-Towel’, where Z is short for ‘Zaka’ or ‘Zāka’ or ‘Zākâ’.

### SUMMARY OF THE INVENTION

Among the various aspects of the present disclosure is a towel cleaning device capable of being secured to the arm. The towel cleaning device includes: a first side, a second side, and an opening through the first side and second side of the towel.

The towel cleaning device is made of a material. The material is preferably a rectangular material. The second side of the towel cleaning device is opposite of the first side, and corresponds in shape to the first side. In one embodiment, the two sides of the towel cleaning device are coupled together throughout the plane of the towel, along the outer perimeter of the device, and along the perimeter of the opening.

Another embodiment of the present disclosure is the first side and second side comprise the same material. Optionally, another embodiment is the first side and second side comprise different materials, provided that at least the first side comprises a material suited for cleaning and sweeping.

Another embodiment of the present disclosure is the first side and/or second side is capable of supporting a design element. The design element may be, but is not limited to, depictions of religious symbols, sports team logos, company logos, fictional and non-fictional characters and settings, depictions of nature, depictions of one or more animals, words, phrases, emojis, and shapes. The design elements may be additional material coupled to the first side and/or second side of the towel; or, the design elements may be incorporated within the material as an embroidered or stitched design element. The additional material for the design element may comprise the same or different material than that of the first side and/or second side of the towel.

In another embodiment of the present disclosure the opening is suitable to fit around any part of an arm. The opening can be large enough to allow an arm to fit through the opening while also securing the towel cleaning device in place to prevent it from inadvertently slipping off the arm.

The towel invention is particularly useful for keeping a cleaning device immediately accessible when the need to clean arises, while keeping the hands free to manipulate other objects when not cleaning. The invention allows for optimal securing of the towel on the arm, more particularly on the forearm, even more particularly on the wrist. This may be beneficial, for example, to avoid the need to clip or otherwise secure a cleaning device away from the hands and wrist; for example, on a belt loop, in a shirt pocket, in a pant pocket, or on another object. In one embodiment, the towel invention is non-obstructing.

An optional embodiment of the invention is that it is useful for caretakers of children.

An optional embodiment of the invention is that it is useful for lecturers, including but not limited to teachers, professors, or ministers.

An optional embodiment of the invention is that it is useful for athletes to wipe sweat and dirt.

An optional embodiment of the invention is that it is useful for a spectator at a sporting event, or any event indoor or outdoor where one could sweat.

An optional embodiment of the invention is that it is useful for any activity where an individual is exposed to the elements in order to wipe sweat, rain, dirt, grime, etc.

An optional embodiment of the invention is that it is useful for individuals with limited mobility, particularly with limited mobility of the hands, including but not limited to individuals having multiple sclerosis (MS), arthritis, coordination issues, paralysis, stroke, cerebral palsy, muscular dystrophy, or spinal cord injuries.

Other features and aspects of the disclosure are described in detail below.

### BRIEF DESCRIPTION OF THE DRAWINGS

FIG. 1 is a front view of the towel cleaning device facing out of the plane of the figure towards the viewer. The second side of the towel cleaning device is opposite the first side and faces into the plane of the figure (second side not shown).

FIG. 2 is a similar perspective view as shown in FIG. 1, with focus on various measurements of the towel cleaning device, including outer dimensions and positioning of the opening.

FIG. 3 is a similar perspective view as shown in FIG. 1, showing embodiment comprising a design element on either the first side of the towel cleaning device or the second side of the towel cleaning device, provided that the opposite side is used for the method of cleaning.

### DETAILED DESCRIPTION OF THE INVENTION

When introducing elements of the various embodiment(s) of the present disclosure, the articles “a”, “an”, “the” and “said” are intended to mean that there are one or more of the elements. The terms “comprising”, “including” and “having” are intended to be inclusive and mean that there may be additional elements other than the listed elements.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Consequently, recitation of ranges of values herein are merely intended to serve as a shorthand method of referring individually to each separate value falling within the range, unless otherwise indicated herein, and each separate value is incorporated into the specification as if it were individually recited herein.

The first side of the towel and the second side of the towel are collectively known as the sides of the towel. The side of the towel that is primarily used for cleaning is also known as the cleaning side of the towel in the present disclosure. The side of the towel that primarily is used to show a design is also known as the design side of the towel.

In the present disclosure, the term “cleaning” can refer to washing, scrubbing, wiping, cleansing, sponging, absorbing, mopping, swabbing, rinsing, scouring, polishing, disinfecting, dabbing, clearing, among other similar terms in the art. The object or objects to be cleaned comprise solids and liquids that are unwanted in one's environment and/or on one's body. Examples of unwanted solids include but are not limited to dust, dirt, grime, food crumbs, shavings, vomit, and excrement. Examples of unwanted liquids include but are not limited to water, sweat, tears, blood, spilled beverage, and oil. The unwanted solids and liquids can be referred to as a “mess”.

In the present disclosure, the arm includes the shoulder, upper arm, forearm, wrist, and hand.

In the present disclosure, the first side and second side of the towel cleaning device comprise a material. Preferably, the first side and second side of the towel cleaning device comprise a rectangular material. In one embodiment, the material includes any type of cloth or fabric that is absorbent, has been woven, knitted, tufted, knotted, or bonded together, or both. The material can include, but is not limited to, terrycloth, cotton, organic cotton, Egyptian cotton, Turkish cotton, Pima cotton, microfiber, bamboo, linen, lace, and synthetic fibers including nylon, polyester, rayon, and spandex.

In the present disclosure, an opening can be a hole, slit, gap, or the like, that allows objects to pass through a solid medium. Said object of the present disclosure preferably includes an arm of an individual. Said solid medium is the towel cleaning device. Said opening, hole, slit, or gap passes completely through the towel cleaning device. This leads to the opening, hole, slit, or gap having two sides, corresponding to the first side and the second side of the towel cleaning device. The arm can enter the opening from the first side of the towel cleaning device, pass through the material of the towel, and exit the opening from the second side of the towel cleaning device. The opening can be located in the pile area of the towel cleaning device.

In the present disclosure, a rectangle is a plane figure with straight sides. Rectangles have a first dimension and a second dimension. The rectangle comprises four sides, where two opposite sides of the first dimension are equal in length, and the two opposite sides of the second dimension are equal in length. A square is a rectangle with the first dimension and second dimension equal in measurement.

In the present disclosure, the “pile” area describes the large area of the towel comprising a raised surface of the towel material and may comprise upright loops or strands of fabric.

In the present disclosure, the “outer edge” of the towel may comprise several features. A feature that may be present in the outer edge of a towel of the invention is the selvage, which is so finished as to keep the outer edge from unraveling or fraying. Another feature that may be present in the outer edge of a towel is the beginning and end parts, also known as top and bottom parts. Beginning and end parts are generally wider than the selvage and are formed by folding the material and sealing it to the edge of the pile are as to prevent unraveling or fraying.

In the present disclosure, “border” describes an optional feature of towels located in the pile area that comprises stitching or patterns of different or similar texture to the pile area and different or similar color to the pile area. In an optional embodiment the border is located in the pile area and surrounds the opening. The border feature can be used for decorative purposes, or it can also help in preventing unraveling or fraying.

In the present disclosure, a “fringe” is an optional embellishment that can be added to the beginning part and end parts of a towel, but may also be optionally added to the selvage. Examples of fringes can be, but are not limited to, simple fringes, tassels, braided fringes, braided tassels, pom-pom fringes, pom-pom tassels.

In the present disclosure, a unit of measurement preferably refers to the magnitude of a distance or length. Measurements are can be expressed in units including but not limited to inches, feet, centimeters, and meters.

Reference will now be made in detail to specific embodiments or features, which are exemplified in the accompanying figures. References to various elements described herein are made collectively or individually when there may be more than one element of the same type, for instance, “opening”. Any reference to an element in the singular may also be construed to relate to plural elements and vice versa without limiting the scope of the disclosure to the exact number or type of such elements. The exemplary embodiments described below are provided for illustrative purposes and should not be construed as limiting. Other exemplary embodiments are possible, and modifications may be made to the exemplary embodiments detailed below within the scope of the disclosure.

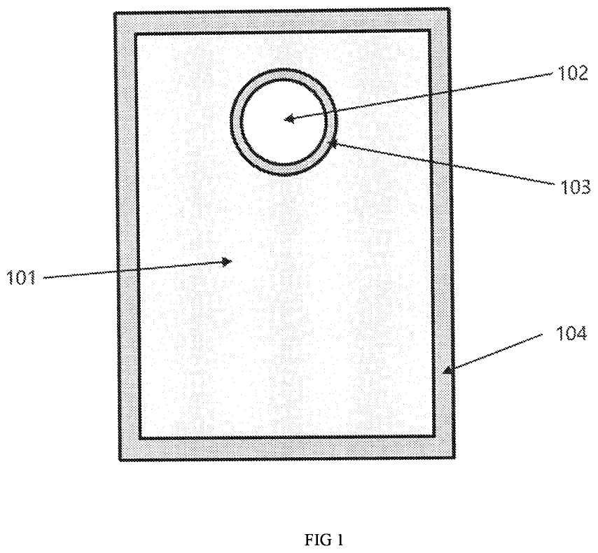

Referring to FIG. 1, in one embodiment, the towel cleaning device includes a pile area 101 which makes up the majority of the surface area of the towel. The towel cleaning device includes an opening 102 located in the pile area 101, in which the arm of an individual can pass through said opening to allow the individual to wear the towel cleaning device as an accessory. The opening 102 can optionally have an edge 103 so finished as to prevent the material along the edge of the opening 102 from unraveling or fraying and can be a border. The towel cleaning device can optionally have an outer edge 104 that surrounds the pile area 101 so finished as to prevent the material along the edge of the pile area 101 from unraveling or fraying and can be a border.

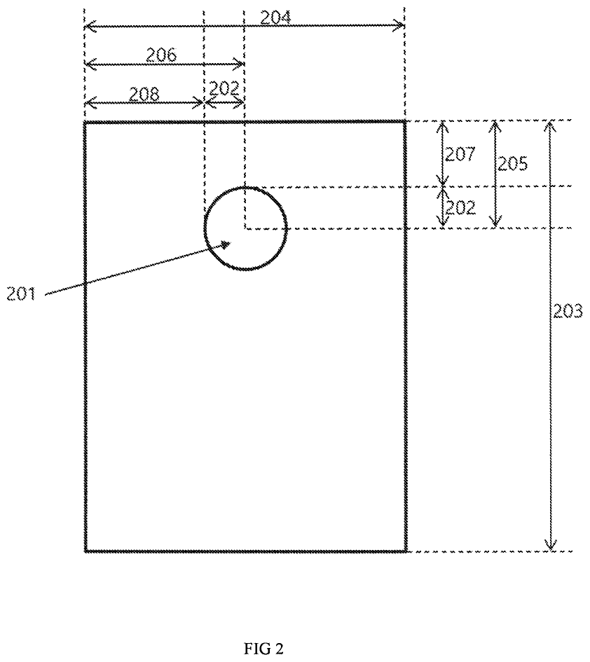

Referring to FIG. 2, the towel cleaning device is shown with opening 201, as described in FIG. 1 element 101. The size of the opening 201 is defined by its radius 202. The radius defined by 202 ranges from at least 0.25 inches, at least 0.30 inches, at least 0.35 inches, at least 0.40 inches, at least 0.45 inches, at least 0.50 inches, at least 0.55 inches, at least 0.60 inches, at least 0.65 inches, at least 0.70 inches, at least 0.75 inches, at least 0.80 inches, at least 0.85 inches, at least 0.90 inches, at least 0.95 inches, at least 1.00 inches, at least 1.10 inches, 1.20 inches, 1.30 inches, 1.40 inches, 1.50 inches, 1.60 inches, 1.70 inches, 1.80 inches, 1.90 inches, 2.00 inches, 2.25 inches, 2.50 inches, 2.75 inches, or at least 3.00 inches. The size of the towel cleaning device is defined by a first dimension 203 and a second dimension 204. First dimension 203 may be greater in magnitude than second dimension 204. First dimension 203 may be equal in magnitude to second dimension 204. First dimension 203 may be smaller in magnitude than second dimension 204. First dimension 203 and second dimension 204 range in length from at least 6.0 inches, at least 6.5 inches, at least 7.0 inches, at least 7.5 inches, at least 8.0 inches, at least 8.5 inches, at least 9.0 inches, at least 9.5 inches, at least 10.0 inches, at least 10.5 inches, at least 11.0 inches, at least 11.5 inches, at least 12.0 inches, at least 12.5 inches, at least 13.0 inches, at least 13.5 inches, at least 14.0 inches, at least 14.5 inches, at least 15.0 inches, at least 15.5 inches, at least 16.0 inches, at least 16.5 inches, at least 17.0 inches, at least 17.5 inches, at least 18.0 inches, at least 18.5 inches, at least 19.0 inches, at least 19.5 inches, at least 20.0 inches, at least 21.0 inches, at least 22.0 inches, at least 23.0 inches, at least 24.0 inches, at least 25.0 inches, at least 26.0 inches, at least 27.0 inches, at least 28.0 inches, at least 29.0 inches, at least 30.0 inches, at least 31.0 inches, at least 32.0 inches, at least 33.0 inches, at least 34.0 inches, at least 35.0 inches, at least 36.0 inches, at least 39.0 inches, at least 42.0 inches, at least 45.0 inches, or at least 48.0 inches. The position of the opening 201 in this figure is defined in the y-axis direction by 205, which is the shortest distance between the center of opening 201 to the edge of the towel cleaning device defined by second dimension 204. The position of opening 201 is also defined in the x-axis direction by 206, which is the shortest distance between the center of opening 201 to the edge of the towel cleaning device defined by first dimension 203. 207 is defined in the y-axis direction, which is the shortest distance between the edge of opening 201 and the edge of the towel cleaning device defined by second dimension 204. 208 is defined in the x-axis direction, which is the shortest distance between the edge of opening 201 and the edge of the towel cleaning device defined by first dimension 203. The ratio between 205 and 203 can be 1:2, 1:3, 1:4, 1:5, 1:6, 1:7, 1:8, 1:9, or 1:10, with the proviso that 207 is not defined by a measurement with a unit of zero. The ratio between 206 and 204 can be 1:2, 1:3, 1:4, 1:5, 1:6, 1:7, 1:8, 1:9, or 1:10, with the proviso that 208 is not defined by a measurement with a unit of zero. In an optional embodiment, the perimeter of the towel cleaning device defined by the first dimension 203 and second dimension 204 is one continuous boundary defining the perimeter, such that the towel cleaning device is in the shape of an oval, circle, heart, or other shape.

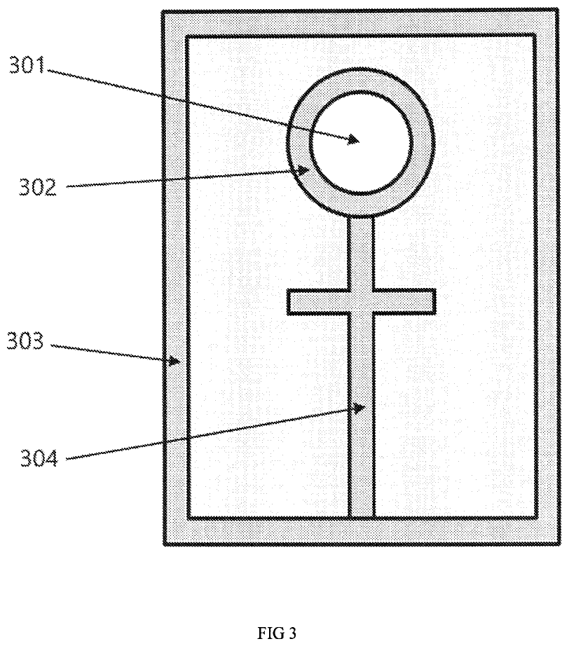

FIG. 3 is an embodiment of the towel cleaning device comprising design elements on the first side or second side of the towel. The towel cleaning device is shown with opening 301, described in FIG. 1 element 101. An option embodiment of the design side of the towel cleaning device is a design element 302 surrounding the perimeter of opening 301. Another optional embodiment of the design side of the towel cleaning device is a design element 303 that surrounds the perimeter of the towel cleaning device. Yet another optional embodiment of the design side of the towel cleaning device is a design object 304 depicting a cross.

In the embodiments of the present disclosure, the material of the first side and the second side of the towel cleaning device can include an absorbent material, a fireproof material, and/or a material suited to pick up dust.

In the embodiments of the present disclosure, the material of the first side and the second side of the towel cleaning device is absorbent. The material can include, but is not limited to, terrycloth, cotton, organic cotton, Egyptian cotton, Turkish cotton, Pima cotton, microfiber, bamboo, linen, lace, and synthetic fibers such as nylon, polyester, rayon, and spandex.

In the embodiments of the present disclosure, the first side and/or second side is capable of supporting a design element. The design element may be, but is not limited to, depictions of religious symbols, sports team logos, company logos, fictional and non-fictional characters and settings, depictions of nature, depictions of one or more animals, words, phrases, emojis, and shapes. The design elements may be additional material coupled to the first side and/or second side of the towel; or, the design elements may be incorporated within the material as an embroidered or stitched design element. The additional material for the design element may comprise the same or different material than that of the first side and/or second side of the towel.

In an optional embodiment of the present disclosure, the opening may be double-knitted to prevent unraveling or fraying around the opening or have a border.

In yet another optional embodiment of the present disclosure, the opening may be formed with a band of material, or one or more strips of material, that wrap around the arm to secure the invention in place. The band of material may be the same material as the pile area of the towel cleaning device, or it may be different material from the pile area of the towel cleaning device. The band of material can be wrapped or fastened around one's arm to secure the towel cleaning device to the arm, rather than sliding one's arm into the opening to secure the towel cleaning device to the arm. The band may be secured around the arm using Velcro, snaps, buttons, or zippers. In some embodiments, the band or strips of material can be made of elastic, spandex, or Velcro. In other embodiments, the band or strips of material can be made of the same materials as the towel device.

In yet another optional embodiment of the present disclosure, the edge of the opening or border may be a material capable of stretching to allow a secure fit around an individual's arm. In one embodiment, the edge of the opening or border can be made of elastic materials, for example spandex. In other embodiment, the edge of the opening or border can be made of the same material as the towel device, or made of different material.

In yet another optional embodiment of the present disclosure, a side of the towel cleaning device is able to be separated or detached from the other side. The detached side is thus able to be washed and reused. In one embodiment, the first side may be fastened to the second side by Velcro, snaps, buttons, or zippers. In yet a further optional embodiment, a design element can be present on the pile area of the first side of the towel cleaning device. The pile area of the first side of the towel cleaning device, along with the design element, is able to be separated or detached from the second side.

In another optional embodiment of the present disclosure, the device can comprise a pocket or envelope-like opening. In yet a further optional embodiment, an pocket opening is present along the sewn boundary between the material of the first side and the material of the second side. The pocket opening allows the space between the pile area of the first side and the pile area of the second side to be used as a pocket or envelope-like device used to discreetly store small items in the event a purse or wallet is not being carried by the individual. The pocket opening may be along the first dimension of the towel cleaning device and may be fastened shut by Velcro, snaps, buttons, or zippers.

In yet another optional embodiment of the present disclosure, a pocket can be attached to the first side and/or the second side of the towel cleaning device. The material of the pocket may be the same as the material of the pile area, or the material of the pocket may be a different material than that of the pile area. Another optional embodiment includes a design element on the pocket. The pocket may be used for storing small items, or for folding the material of the towel cleaning device within the pocket when storing away the towel cleaning device for later use.

In another optional embodiment, the towel cleaning device can comprise a detachable design element. For example, the detachable design element can be located on a first side of the towel cleaning device and be separated from the first side for cleaning the towel device and design element separately.

In yet another optional embodiment, the use of the towel cleaning device can include additional use of chemical cleaners. Chemical cleaners include, but are not limited to: soaps, disinfectants, degreasers, shampoos, detergents, aerosol cleaners, spray cleaners, fabric cleaners, window cleaners, adhesive removers, alcohols, bleaches, and peroxides.

In one embodiment, the towel cleaning device is useful for caretakers of small children in keeping their hands free, yet have quick access to a cleaning device should a mess be made. In another embodiment, the towel cleaning device is useful for doctors, obstetricians, midwives, dentists, nursing home professionals, and other medical professionals to utilize the towel cleaning device in cleaning up after patients. In another embodiment, the towel cleaning device is useful for lecturers in keeping their hands free to grab books, chalk, pointing sticks, among other objects, all while having quick access to a cleaning device to wipe sweat from the lecturer's own face when sweating. In yet another embodiment, the towel cleaning device is useful for athletes to keep their hands free to play a sporting activity, all while having quick access to a cleaning device to wipe sweat or dirt as a result of physical activity. In yet another embodiment, the towel cleaning device is useful for spectators of sporting events or other indoor or outdoor events to wave and spin the towel on their raised arms to cheer at the event, and keep their hands free to consume food and refreshments; all while having quick access to a cleaning device to wipe sweat or other messes. In yet another embodiment, the towel cleaning device is useful for any activity where an individual is exposed to the elements in order to wipe sweat, rain, dirt, grime, etc. In yet another embodiment, the towel cleaning device is useful to wipe sweat from an individual's body, for example from the individual's head, face, neck, chest, stomach, back, arm, leg, or foot. In yet another embodiment, the towel cleaning device is useful for keeping one's hands free while taking care of a pet, yet have quick access to a cleaning device should a mess be made. In yet another embodiment, the towel cleaning device is useful for a professional pet groomer in keeping their hands free to focus on grooming a pet, yet have quick access to a cleaning device should a mess be made. In yet another embodiment, the towel cleaning device is useful for individuals washing cars, drying cars, and cleaning jobs on leather, upholstery, and dashboards.

An embodiment of the present disclosure includes a method for cleaning comprising using the towel cleaning device to clean a mess, wherein the towel is capable of being secured to a wrist. Securing the towel to the wrist can be used by an individual, for example a caretaker of children, to keep the individual's hands free, yet have quick access to a cleaning device should a mess need cleaning.

In one embodiment, a method for cleaning comprises using the towel cleaning device, wherein the towel is capable of being secured to a wrist and can be used by a doctor, obstetrician, midwife, dentist, nursing home professional, and other medical professional to utilize the towel cleaning device in cleaning up after patients.

In another embodiment, a method for cleaning comprises using the towel cleaning device, wherein the towel is capable of being secured to a wrist and can be used by a lecturer to keep their hands free to grab or hold a microphone, book, chalk, pointer, lectern, podium, or other objects, while having quick access to a cleaning device to wipe sweat from the lecturer's face.

In yet another embodiment, a method for cleaning comprises using the towel cleaning device, wherein the towel is capable of being secured to a wrist and can be used by an athlete to keep their hands free to play a sporting activity, while having quick access to a cleaning device to wipe sweat or dirt, for example created as a result of physical activity.

In yet another embodiment, a method for cleaning comprises using the towel cleaning device, wherein the towel is capable of being secured to a wrist and can be used by spectators of sporting events or other indoor or outdoor events to wave and spin the towel on their raised arms to cheer at the event, and keep their hands free to consume food and refreshments; all while having quick access to a cleaning device to wipe sweat or other messes.

An embodiment of the present disclosure includes a method for cleaning comprising using the towel cleaning device, wherein the towel is capable of being secured to a wrist which allows an individual involved in an activity to wipe sweat, rain, dirt, grime, etc.

An embodiment of the present disclosure includes a method for cleaning comprising using the towel cleaning device, wherein the towel is capable of being secured to a wrist which allows an individual to wipe sweat from one's body, for example from the individual's head, face, neck, chest, stomach, back, arm, leg, or foot.

In yet another embodiment, a method for cleaning comprises using the towel cleaning device, wherein the towel is capable of being secured to a wrist and can be used by an individual taking care of a pet, yet have quick access to a cleaning device should a mess be made.

In yet another embodiment, a method for cleaning comprises using the towel cleaning device, wherein the towel is capable of being secured to a wrist and can be used by a professional pet groomer in keeping their hands free to focus on grooming a pet, yet have quick access to a cleaning device should a mess be made.

In yet another embodiment, a method for cleaning comprises using the towel cleaning device, wherein the towel is capable of being secured to a wrist and can be used by individuals washing cars, drying cars, and cleaning jobs on leather, upholstery, and dashboards.

The description above includes exemplary devices, methods, techniques, and/or steps that embody techniques of the present invention. However, it is understood that the described invention may be practiced without these specific details. The above description of example embodiments does not define or constrain this disclosure. Other changes, substitutions, alterations, cleaning uses, and cleaning methods are also possible without departing from the spirit and scope of this disclosure.

What is claimed is:

1. A device comprising:
a. a first side;
b. a second side;
c. wherein the first side and the second side comprise a material; and
d. wherein the device comprises an opening that passes through the first side to the second side.

2. The device of claim 1, wherein the device is a towel.

3. The device of claim 1, wherein the opening is suitable to pass a human arm through said opening.

4. The device of claim 1, wherein the device is a human-wearable towel.

5. The device of claim 1, wherein the opening is capable of securing the device on the arm of an individual.

6. The device of claim 5, wherein the opening is surrounded by an elastic border.

7. The device of claim 1, wherein the material of the first side and material of the second side is suitable for cleaning.

8. The device of claim 1, wherein the second side comprises a design element.

9. The device of claim 8, wherein the design elements are comprised of the same material as the device.

10. The device of claim 9, wherein the same material is a stitched design element.

11. The device of claim 1, wherein the design element is comprised of a different material than that of the device.

12. A method for cleaning, comprising:
a. placing the device of claim 1 on an arm of an individual;
b. securing the device of claim 1 on the arm;
c. grasping the second side of the device with a hand located on the arm;
d. passing the first side over an area to be cleaned;
e. releasing the second side;
f. freeing the hands to go about other tasks; and
g. keeping the device of claim 1 secured on the arm.

13. The method of claim 12 further comprising use of a cleaner.

14. The method of claim 13, wherein the cleaner is a chemical cleaner.
